(19) United States
(12) Patent Application Publication
(10) Pub. No.: US 2026/0163029 A1
(43) Pub. Date: Jun. 11, 2026

(54) METHOD FOR OPERATING A FUEL CELL SYSTEM, AND A CONTROL DEVICE

(71) Applicant: Robert Bosch GmbH, Stuttgart (DE)

(72) Inventors: Timo Bosch, Renningen (DE); Tobias Falkenau, Esslingen (DE)

(21) Appl. No.: 19/124,381

(22) PCT Filed: Oct. 24, 2023
(86) PCT No.: PCT/EP2023/079596

§ 371 Date: Apr. 25, 2025

(30) Foreign Application Priority Data
Oct. 28, 2022 (DE) 10 2022 211 438.8

(51) Int. Cl. H01M 8/04119; H01M 8/0438; H01M 8/04537

(52) U.S. Cl. CPC H01M 8/04179; H01M 8/04388; H01M 8/04597

(57) ABSTRACT

The invention relates to a method for operating a fuel cell system (1), hydrogen from a tank (21) and recirculated hydrogen from a recirculation circuit (50) being supplied to at least one fuel cell (101) via a fuel line (20) as anode gas, and the anode gas being removed from the recirculation circuit (50) by intermittently opening a purge valve (41),

characterized in that the following steps are carried out:
opening the purge valve (41)
sensing the pressure drop in the fuel line (20) upstream of a hydrogen metering valve (51),
checking whether the valve characteristic of the purge valve (41) matches a molar flow calculated from the pressure drop.

The invention further relates to a control device for carrying out the method or individual method steps.

### BACKGROUND

The invention relates to a method for operating a fuel cell system. Furthermore, the invention relates to a control device configured so as to carry out the steps of the method.

A PEM fuel cell comprises a polymer electrolyte membrane arranged between an anode and a cathode. Using the PEM fuel cell, hydrogen fed to the anode and oxygen fed in the form of air to the cathode can be converted into electrical energy, heat, and water. In practical application, a plurality of fuel cells are gathered together to form a fuel cell stack, also known as a “stack,” in order to increase the generated electric voltage.

Through diffusion processes via the fuel cell, nitrogen enters the recirculation circuit on the side of the anode. A further source of nitrogen is the fresh fuel, which is not 100% pure H2. Nitrogen represents an inert gas for the fuel cell, reducing the cell voltage and thus the stack voltage, which in turn results in a loss of efficiency. Therefore, anode gas is discharged repeatedly from the recirculation circuit during a travel cycle in order to reduce the nitrogen content. This discharge is carried out with the so-called purge valve.

According to the prior art, fresh hydrogen is supplied by means of hydrogen metering valves, which can be designed as proportional valves. The control strategy provides that this valve be used to regulate the gas pressure within an anode path, measured by a pressure sensor at a defined position, to a defined target pressure depending on the system operating point. It may be necessary to feed additional fresh hydrogen due to a) consumption of H2 by the electrochemical conversion b) other losses of gas molecules from the anode space due to opening the drain valve for a long period of time when gas is discharged after complete water drainage and by opening of the purge valve.

### SUMMARY

The object of the present invention is therefore to specify a method for operating a fuel cell system that provides reliable and at the same time cost-efficient monitoring of the purge valve.

At the same time, the functionality of the medium pressure sensor in the fuel line may be checked.

The object is achieved by the method according to the disclosure. Advantageous embodiments of the invention can be gathered from the dependent claims. In addition, a control device for carrying out the method or individual method steps is specified.

In the proposed method for operating a fuel cell system, hydrogen from a tank and recirculated hydrogen from a recirculation circuit ais fed to at least one fuel cell as anode gas via a fuel line. As nitrogen, water, and to a minor extent other gases accumulate in the anode gas of the recirculation circuit over time, the anode gas is removed from the system by temporarily opening a purge valve.

The following steps are carried out:
opening the purge valve,
sensing the pressure in the fuel line upstream of a hydrogen metering valve,
checking whether the valve characteristic of the purge valve matches a molar flow calculated from the pressure drop.

When the purge valve is opened, anode gas escapes from the recirculation circuit upon opening the purge valve. The target pressure in the recirculation circuit changes and falls below the target pressure. To maintain the target pressure, hydrogen must flow downstream into the recirculation circuit via the hydrogen metering valve. To meet the increased demand for hydrogen, the opened hydrogen metering valve is opened even further. This occurs abruptly and can be sensed as a pressure change in the fuel line upstream of the hydrogen metering valve.

By means of the proposed method according to the invention, the pressure change in the fuel line can be used to determine how much anode gas has left the recirculation circuit through the purge valve. Said molar flow can be used to calibrate the valve characteristic of the purge valve. This is advantageous because the purge valve can have a production-related variation of the valve characteristic (volume flow over pressure) of up to +−10%. The valve characteristic also drifts over the service life. Thus, the purge valve, and thus the fuel cell system regulation, may be easily calibrated by the proposed method. This leads to lower hydrogen consumption in total.

It is advantageous if the signal from a pressure sensor in the fuel line is evaluated to detect the sudden change in pressure in the fuel line, as this is a simple and accurate way of detecting a change in pressure.

There is a further advantage if the actuator current for controlling the hydrogen metering valve is evaluated to detect the sudden change in pressure in the fuel line, as no additional costs are incurred by the pressure sensor.

Furthermore, it is proposed that signals that are used as the basis for the evaluation of the actuator current are previously subjected to a filtering and/or averaged over time. In this way, the accuracy of the evaluation can be increased.

A debounce time of the purge valve may be considered when evaluating the pressure. This means that a certain time offset between activating and opening of the purge valve is included in the evaluation. In this way, the accuracy of the evaluation can be further increased.

In order to ensure that only hydrogen from the tank is still present in the recirculation circuit, it is advantageous to wait until the pressure drop in the fuel line has reached a plateau value. In this way, one can infer the gas composition in the recirculation circuit, said composition having been determined in advance by system tests depending on the system operation.

In a fuel cell system comprising at least two fuel cell stacks each having a fuel line, a recirculation circuit, and a purge valve, respectively, it is advantageous to operate the purge valves decoupled from each other so that only one purge valve can be opened at a time. In this way, the pressure drop can be clearly associated with one purge valve.

In addition, a control device that is configured so as to carry out steps of the method according to the invention is proposed. In particular, the actuator current required to actuate the hydrogen metering valve can be acquired and evaluated using the control device. To evaluate the actuator current, a corresponding algorithm is preferably stored in the control device.

### BRIEF DESCRIPTION OF THE DRAWINGS

The invention and the advantages thereof are explained in more detail below with reference to the accompanying drawings:

FIG. 1 shows a schematic illustration of a topology of a fuel cell system according to a first exemplary embodiment, and

FIG. 2 shows a schematic illustration of a topology of a fuel cell system according to a second exemplary embodiment.

### DETAILED DESCRIPTION

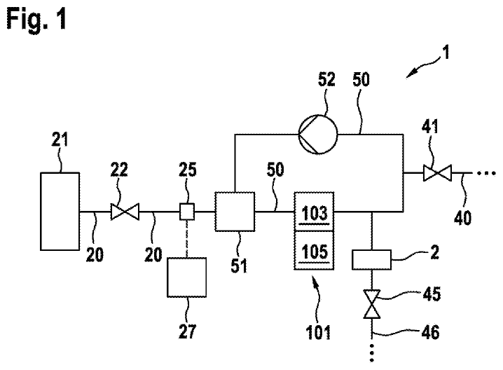

FIG. 1 shows a schematic topology of a fuel cell system 1 according to a first exemplary embodiment of the invention, having at least one fuel cell stack 101.

The fuel cell stack 101 has a cathode side 105 and an anode side 103. The anode side 103 is supplied with hydrogen via a fuel line 20. The fuel line 20 is located between a pressure control valve 22 and a hydrogen metering valve 51.

A high-pressure tank 21 connected to the pressure control valve 22 via a further line is present upstream of the pressure control valve 22. Additional components can be arranged in the further line and in the fuel line 20 so as to supply fuel to an anode side 103 of the fuel cell stack 101 as needed. By means of the pressure control valve 22, enough hydrogen flows into the fuel line 20 so that the pressure in the fuel line 20 is maintained at the most constant value possible.

Excess fuel, as well as certain amounts of water and nitrogen that diffuse through the cell membranes onto the anode side 103, are returned to a recirculation circuit 50 and mixed with the metered fuel from the fuel line 20.

Various components, such as a fan 52 or a jet pump, may be installed to drive the flow in the recirculation circuit 50. The hydrogen metering valve 51 is arranged at the transition between the fuel line 20 and the recirculation circuit 50.

The hydrogen metering valve 51 ensures the supply of fresh hydrogen to the recirculation circuit 50. The hydrogen metering valve 51 can be designed as a proportional valve. The control strategy in the fuel cell system 1 provides for using the hydrogen metering valve 51 to regulate the gas pressure within the recirculation circuit 50 to a defined target pressure depending on the system operating point. Reasons for the replenishment of fresh hydrogen can be the consumption of hydrogen by the electrochemical conversion within the fuel cell stack 101 or other losses of gas molecules from the recirculation circuit 50, such as due to opening of the drain valve 45 or the purge valve 41.

In the event of a change in the operating point, larger or smaller amounts of hydrogen are temporarily conveyed from the fuel line 20 to the recirculation circuit 50 by the hydrogen metering valve 51. As the behavior of the pressure control valve 22 reacts more slowly than the hydrogen dosing valve 51, fluctuations in the pressure in the fuel line 20 may occur briefly.

A water separator 2 is integrated in the recirculation circuit 50 to separate water from the anode gas in the recirculation circuit 50. The water separator 2 has a container for collecting the separated water. In order to empty this container, the water separator 2 is connected to a drain valve 45 via a drain line 46. The drain line 46 typically discharges the excess water into an exhaust line, which is connected to the surrounding environment.

A pressure sensor 25 is arranged in the fuel line 20. The pressure sensor 25 is arranged upstream of the hydrogen metering valve 51 and measures the pressure between the pressure regulator 22 and the hydrogen metering valve 51 in the fuel line 20.

The method according to the invention provides that, after opening and during opening of the purge valve 41, or as soon as the purge valve 41 is opened, the pressure in the fuel line 20 is sensed upstream of the hydrogen metering valve 51.

The pressure drop within the fuel line 20 resulting from the opening of the purge valve 41 can be used to calculate the molar flow that has flowed through the purge valve 41 from the recirculation circuit 50.

Said molar flow, resulting from a calculation based on the pressure drop in the fuel line 20, is now compared to the molar flow resulting from the valve characteristic of the purge valve 41.

A valve characteristic is provided for the purge valve 41 and indicates the flow or the flow coefficient as a function of the valve stroke. The flow rate can then be determined using the flow coefficient and the pressure drop applied to the valve.

The valve characteristic of the purge valve 41 or the molar flow resulting therefrom can be compared to the molar flow calculated from the pressure drop in the fuel line 20. If there is a deviation, the purge valve 41 and thus the fuel cell system regulation may be recalibrated.

For this purpose, a new valve characteristic is stored in a control unit of the fuel cell system 1.

To sense the pressure in the fuel line 20, the signal from the pressure sensor 25 in the fuel line 20 may be evaluated according to a first exemplary embodiment.

According to a further embodiment, the actuator current for actuating the hydrogen metering valve 51 may be evaluated to sense the change in pressure in the fuel line 20. If the actuator current rises above a threshold value, a large amount of fuel is fed through the hydrogen metering valve 51 into the recirculation circuit 50. The pressure in the fuel line 20 between pressure control valve 22 and hydrogen metering valve 51 consequently drops.

A control device of the fuel cell system 1 by means of which the hydrogen metering valve 51 is actuated may be used to evaluate the actuator current.

Preferably, no change in the operating conditions or the load should occur during the method according to the invention; if this does occur, any load change that occurs is taken into account when evaluating the actuator current or pressure.

In an alternative embodiment, to determine the molar flow rate, a point is awaited at which the pressure drop in the fuel line 20 has reached a plateau value. This is the case when the anode gas having a mixture of hydrogen, nitrogen, water, and other gases has been completely depleted by the purge valve 41 and only hydrogen from tank 21 remains present in the recirculation circuit 50.

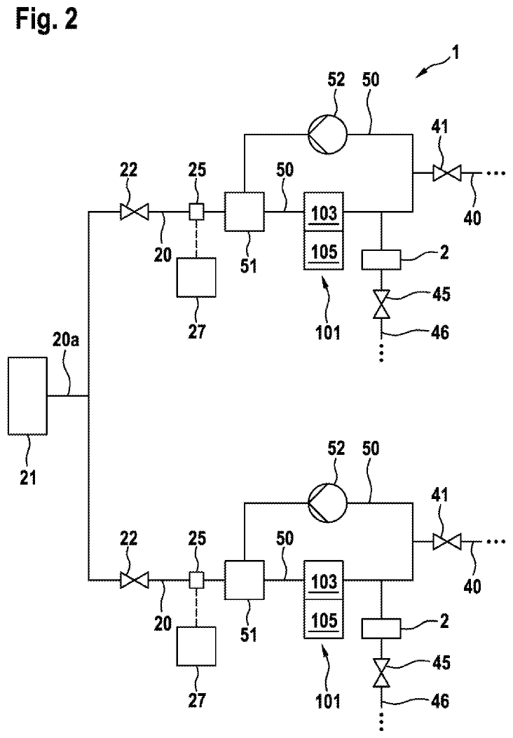

FIG. 2 shows a fuel cell system 1 according to a second exemplary embodiment having at least two fuel cell stacks 101, wherein each fuel cell stack comprises a fuel line 20, a recirculation circuit 50, a purge valve 41, a hydrogen metering valve 51, a pressure control valve 22, and a pressure sensor 25 disposed in the fuel line 20. The further components of the fuel cell system 1 having at least two fuel cell stacks 101 likewise do not differ from the arrangement described in the first exemplary embodiment. A single hydrogen tank 21 or tank system is connected to another line 20a, which has a branch and is connected to the respective pressure control valves 22.

When checking whether the valve characteristic of the purge valve 41 matches a molar flow calculated from the pressure drop, influences and pressure variations should be avoided by opening at least one further purge valve 41. The purge valve 41 can be unambiguously associated with a pressure sensor 25 of the respective fuel cell stack 101 if the purge valves 41 are operated decoupled from one another, such that only one purge valve 41 can be open at a time.

1. A method for operating a fuel cell system (1), in which hydrogen from a tank (21) and recirculated hydrogen from a recirculation circuit (50) are supplied to a fuel cell (101) via a fuel line (20) as anode gas, and the anode gas is removed from the recirculation circuit (50) by intermittently opening a purge valve (41),
wherein the following steps are carried out:
opening the purge valve (41)
sensing a pressure drop in the fuel line (20) upstream of a hydrogen metering valve (51), and
determining whether the valve characteristic of the purge valve (41) matches a molar flow calculated from the pressure drop.

2. The method according to claim 1, wherein the signal of a pressure sensor (25) in the fuel line (20) is evaluated to sense the pressure in the fuel line (20).

3. The method according to claim 1, wherein the actuator current for actuating the hydrogen metering valve (51) is evaluated to sense the pressure in the fuel line (20).

4. The method according to claim 3, wherein control device (27) of the fuel cell system (1) by means of which the hydrogen metering valve (51) is actuated is used to evaluate the actuator current.

5. The method according to claim 2, wherein a comparison of the pressure drop and the evaluated actuator current are carried out to check the function of the pressure sensor (25).

6. The method according to claim 1, wherein to determine the molar flow, a point is awaited at which the pressure drop in the fuel line (20) has reached a plateau value.

7. The method according to claim 1, wherein the fuel cell system (1) comprises at least two fuel cell stacks (101) each having a fuel line (20), a recirculation line (50), and a purge valve (41), wherein the purge valves (41) are operated decoupled from one another such that only one purge valve (41) can be opened at a time.

8. The method according to claim 1, wherein the molar flow rate calculated from the pressure drop is used to calibrate the valve characteristic of the purge valve (41).

9. A control device configured to operate a fuel cell system (1), in which hydrogen from a tank (21) and recirculated hydrogen from a recirculation circuit (50) are supplied to a fuel cell (101) via a fuel line (20) as anode gas, and the anode gas is removed from the recirculation circuit (50) by intermittently opening a purge valve (41),
wherein the control device is further configured to:
control opening of the purge valve (41)
determine, based on information from a sensor, a pressure drop in the fuel line (20) upstream of a hydrogen metering valve (51), and
determine whether the valve characteristic of the purge valve (41) matches a molar flow calculated from the pressure drop.
